(19) United States
(12) Patent Application Publication
(10) Pub. No.: US 2014/0114943 A1
(43) Pub. Date: Apr. 24, 2014

(54) EVENT SEARCH ENGINE FOR WEB-BASED APPLICATIONS

(71) Applicant: Gablit Inc., San Francisco, CA (US)

(72) Inventors: Roger Holenweger, Berkeley, CA (US); Taras Shkvarchuk, Berkeley, CA (US); Allen Jilo, San Francisco, CA (US); Anthony Teale, San Francisco, CA (US); Freddie Godfrey, San Francisco, CA (US)

(73) Assignee: Gablit Inc., San Francisco, CA (US)

(21) Appl. No.: 14/061,664

(22) Filed: Oct. 23, 2013

Related U.S. Application Data
(60) Provisional application No. 61/717,350, filed on Oct. 23, 2012.

(51) Int. Cl. G06F 17/30

(52) U.S. Cl. CPC G06F 17/30864
USPC 707/706

(57) ABSTRACT

Embodiments are described for a system for managing events, including a search engine component configured to allow a user to enter a query to locate an event to be attended by one or more other users; a database interface configured to access and return results from an event data store; a relevancy engine returning the results from the event data store based on textual, categorical, social and personalized indicators; a system for notifying the user of event or entity matches; and a user interface displaying to the user the results in a single unified map and vertical calendar graphical representation.

### CROSS REFERENCE TO RELATED APPLICATIONS

The present application claims priority from U.S. Provisional Patent Application No. 61/717,350 filed on Oct. 23, 2012, entitled “Event Search Engine” and which is incorporated herein by reference in its entirety.

### FIELD OF THE INVENTION

Embodiments are generally directed to Internet search engine technology, and more specifically to event aggregation, discovery and promotion websites.

### BACKGROUND

Present mobile communication and web-based technologies offer a great deal of information and personal tools to help users schedule tasks and activities, and communicate with others. While such tools are typically effective for creating and communicating items of information or data, they are relatively limited with respect to effectively managing events that involve multiple people and/or multiple activities. Planning or attending an event often requires several tools. For example, tools for discovering the event, purchasing tickets, planning transportation, contacting and coordinating with friends, and so on. Much of the information and tools to perform these tasks is fragmented, and thus imposes a high level of coordination and interaction by the user.

In general, an event is a scheduled occurrence for the intended audience of one person or more. Events may be produced for an audience of any number of people ranging from just a few individuals to several hundred thousand people. They can happen anywhere from an apartment living room to a racetrack; they can last anywhere from a few minutes to days on end; and they might be free, or they cost thousands of dollars. Events may encompass many interests and scales of production in a global social system, and therefore the information to describe and encapsulate different events is often disparate and of varied quality in both online and offline information systems. Information may also be re-published and replicated by third parties. Such information is typically published or conveyed in an un-standardized format without a rigid taxonomy or adhering to any web standards. A simple illustration of this fact is the variety of ways in which people from the same geography write the day/date format. This behavior across the descriptions makes the data difficult to identify, classify and understand through programmatic methods. At best these sources are bound by geographies or verticals with delineated expressions of price and time. At worst, even through the most advanced generic search engines, it is a challenge to programmatically identify events, even from known sources of event information adhering to common publishing standards throughout their own infrastructure. Furthermore, limited search data exists on event specific language and as such, custom libraries and dictionaries must be created to help efficiently query the data.

The social web movement generated an online social graph that mirrored relationships in the offline world and facilitated volumes of user-contributed content alongside virtual relationships. It also generated a paradigm shift in behaviour around privacy concerns. However, the action of publishing details about one's future plans has many complicated dynamics that encompass a variety of societal norms, stigmas and associated logics. As a result of some of these issues, only a small subset of the modern user base actually contributed event focused content regarding future occurrences. Consequently, there are severe implications in achieving a full ‘viral loop’ in the event space specifically.

Aside from semantic queries, events in particular have some additional dimensions that govern the search or discovery process. For example location; the start and end point of an event (e.g., a marathon); time and duration; the size of venue; sub-events (e.g., large conferences); past occurrences and how they are connected; recurring events; multi-day events; and personal interests (e.g., friendship, work (business driven) interest, historic interest).

Present consumer applications with access to large databases present personalized recommendations from the vast wealth of knowledge accrued from search inferences and user preferences gleaned from behavioural analysis. Music players such as Spotify and Pandora are good examples that use a collection of behavioural learnings that overlap social influence, historic user indicators (both on platform and third party data) to personalize the passive media consumption experience. However these examples service a media type that has a well-structured taxonomy and sit within large pre-defined data repositories.

Finally there are two separate actions that govern event search and discovery: passive and active states. Active users exhibit alpha behavior (i.e., having the motivation to organize and publish amongst their peers.) The emphasis is on searching for something they already have an awareness of (either by choosing a location or time), or an understanding of what kind of thing they are looking for and then motivating others to join them. Passive users expect to discover content through other means. These users are influenced by the habits of others, rather than directly searching for the information themselves. Consumers are becoming more used to consuming content via programmatically driven recommendations, provided in on and off site methodologies.

As a requirement to cope with these different conditions, different search methodologies are employed, including on-site; similar, channel search, keyword search string, search via entities, venues and profiles, and so on. What is needed is a system that aggregates events and event-related processing onto a single platform through which users can find events, schedule activities, and communicate and share event-related information with others. The system can learn from implicit and explicit behaviours and provide personalized recommendations and deliver tailored search results via active and passive systems both on and off the platform.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a computer network that implements embodiments of an event search engine and user interface.

FIG. 2A illustrates an example web page showing a map view for search visualization, under an embodiment.

FIG. 2B illustrates an example web page showing a vertical calendar (list) interface view for search visualization, under an embodiment.

FIG. 2C illustrates an example of a semantic/keyword driven search interface, under an embodiment.

FIG. 3A is an example web page illustrating a channel-driven search page, under an embodiment.

FIG. 3B illustrates an example web page for channel visualization, under an embodiment.

FIG. 3C is an example web page illustrating a custom channel creation screen, under an embodiment.

FIG. 4A is an example web page illustrating an event display viewport, under an embodiment.

FIG. 4B is an example web page illustrating a scrolled event display viewport, under an embodiment.

FIG. 4C is an example web page illustrating a similar event response, under an embodiment.

FIG. 4D is an example web page illustrating a nearby deal response, under an embodiment.

FIG. 5 illustrates an example web page for a personalized social share recommendation screen, under an embodiment.

FIG. 6A is an example web page of a personalization feature, under an embodiment.

FIG. 6B is an example web page of the personalization of signup preferences, under an embodiment.

FIG. 6C is an example web page of the personalization of events, under an embodiment.

FIG. 7 is a flowchart that illustrates an overall method of managing and processing searches for events through an event management platform.

### SUMMARY OF EMBODIMENTS

Embodiments are directed to a system for managing events, comprising a search engine component configured to allow a user to enter one or more parameters initiate a search to locate an event for an intended audience of one or more other users, a database interface configured to access and return results from an event data store, a relevancy engine returning results for the search from the event data store based on textual, categorical, and social indicators of an event, a graphical user interface (GUI) component to notify and deliver the results to the user by displaying one or more results in a single unified map and vertical calendar graphical representation. The relevancy engine may be configured to combine the textual, categorical, and social indicators with user specific signals and third party data signals and user profiling to generate the result. In the GUI, the results may be displayed in an order tailored according to the user's personalized recommendations. In an embodiment, the search comprises a query including a keyword search string to derive dynamic search channels that can be generated by at least one of: an automatic process executed by the system, customization input by the user, and one or more definitions created entirely by the user. The system may further comprise a location component determining a location of the user through one of a default means or direct user input, and where the location of the user is processed to generate the single unified map. It may also further comprise a scheduling component determining time information related to events stored in the event data store and availability of the user, and wherein the time information is processed to generate the vertical calendar. It may yet further comprise a social network platform configured to allow the user and the one or more other users to share information provided by the event data store.

Embodiments are further directed to a method of managing events and user schedules by receiving and processing a query from a user to locate an event to be considered for attendance by one or more other users, accessing information regarding location and schedules of events from an event data store to return search results to the query, accessing information regarding location and schedules of the user and the one or more other users, and providing a single user interface having a unified map and vertical calendar for display of the search results to the user. The method may further comprise a social network or other external platform configured to allow the user and the one or more other users to specify personal information and to share information provided by the event data store. The method also includes defining one or more relevancy indicators tied to the user and obtained through external interest and social graph data associated with the user. The relevancy indicators may be based on information derived from interactions of the user with other users who have volunteered their data from one or more social networks or from third party profiling services that have granted access to the information. The method may also include linking externally identified event specific signals across social profiles with user engagement with any related event as implicit indicators of interests and influence. In an embodiment, the method enriches a profile of the user by combining the externally identified event specific social profiles with matched data points in an event database to provide implicit and unique behavioural attributes associated with the user. It may also calculate a user specific influence score based on the externally identified event specific signals from online behaviour including across third party networks. The specific influence score may be derived from the specific nature and frequency of occurrences and the resultant engagement within the user's specific social graph.

### DETAILED DESCRIPTION

Embodiments of an activity or event discovery and management platform are described. The platform provides search engine and user interface elements that allows users to create and publish events, search for and discover events, share events with other users, and generally manage and coordinate event tasks using a single application or platform interface. For purposes of the following description, the term ‘event’ is intended to cover any relevant social activity such as a meeting, entertainment event (e.g., sports, music, film, theater, etc), party, gathering, conference, and so on, that generally involves at least one person. Such an event may be public or private, and hosted or held in any appropriate location. The term ‘activity’ may be interpreted to be equivalent to event, or it may imply an act within or related to an event.

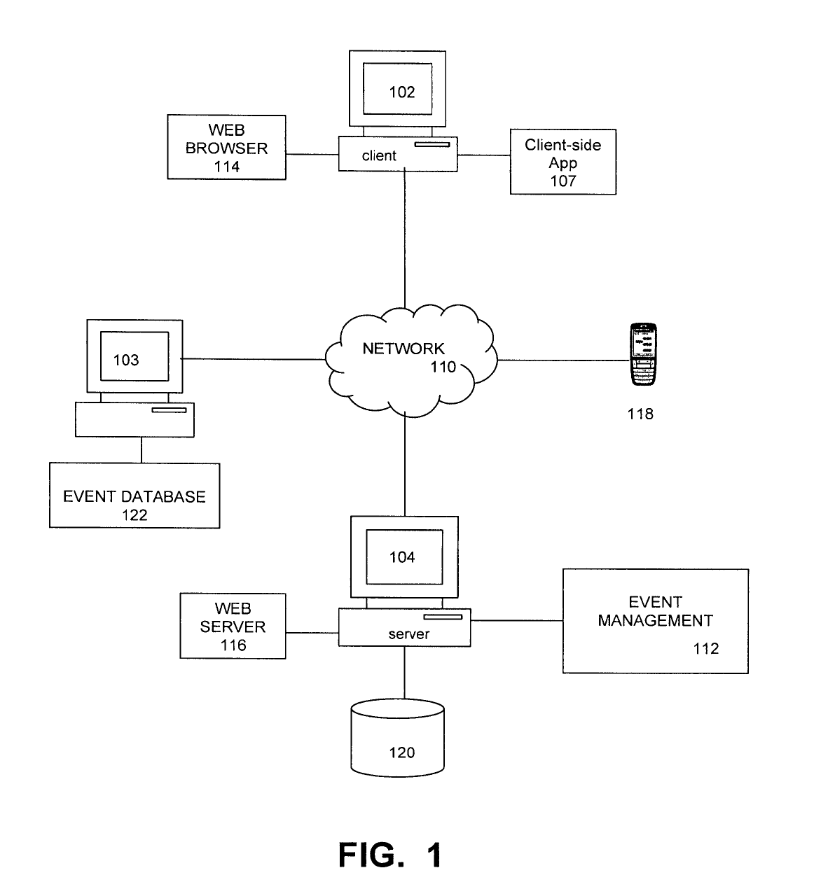

Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof. Network 110 may also represent a cloud-based network environment in which applications, servers and data are maintained and provided through a centralized cloud computing platform.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server-side event management process 112. Client versions of this process 107 may also be executed on the client computers. This process 112 may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP). Data for any of the events, activities, products, services, and the like may be provided by a data store 120 closely or loosely coupled to any of the server 104 and/or client 102. A separate content provider 103 may provide some of the data that is included as part of the event or user information, such as through an event database 122.

The client computer 102 may be a workstation computer or it may be a computing device such as a notebook computer, personal digital assistant, or the like. The client computer may also be embodied within a mobile communication device 118, game console, media playback unit, or similar computing device that provides access to the Internet network 110 and a sufficient degree of user input and processing capability to execute or access the client-side credit application program 107. The client computers 102 and 118 may be coupled to the server computer 104 over a wired connection, a wireless connection or any combination thereof.

As shown in FIG. 1, server computer 104 provides an event management process 112. This process represents an activity or event discovery and management platform that allows a user to discover activities based on keyword searches (“queries”), and/or create digital representations of events for the purpose of promotion to other users of the platform. The event management process 112 may include several different components, such as a search engine component, a data transmission component, a social network communication component, a graphical user interface (GUI or UI), and other such components.

In the context of a discovery platform, the user chooses from a selection of channels that have been created from natural language queries or user chosen strings from a search field, which is processed internally by a relevancy engine accounting for textual, categorical/contextual and social indicators, in order to return results with a high degree of relevancy. Each natural language query is entered individually and relevancy is calculated at that time with matching events being returned as such, but if consecutive keywords are entered without clearing the map/vertical calendar (list) of the previous queries, the relevant results for each keyword are distinctly displayed on a single interface. In addition to keyword queries, a user can filter and update results using time and/or location variables, without the need for the user to refresh the results or load a new page.

In the context of an activity management platform, a user is able to manage multiple aspects of an event or groups of events. The complete management features include, but are not limited to: creating an event or series of events, pushing an event or series of events to third party event websites for simultaneous promotion, and managing multiple brands from a single account.

### Activity Discovery Platform—User Interface

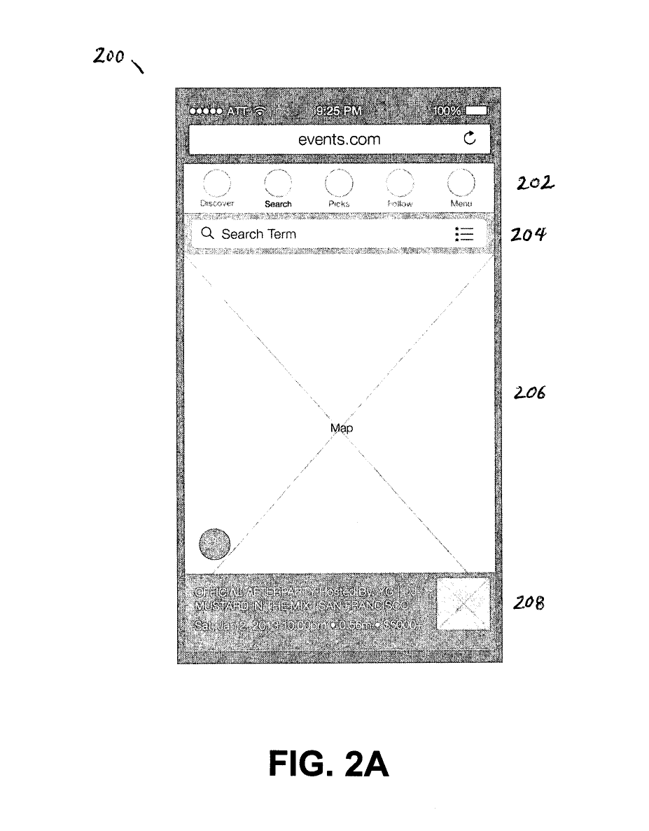

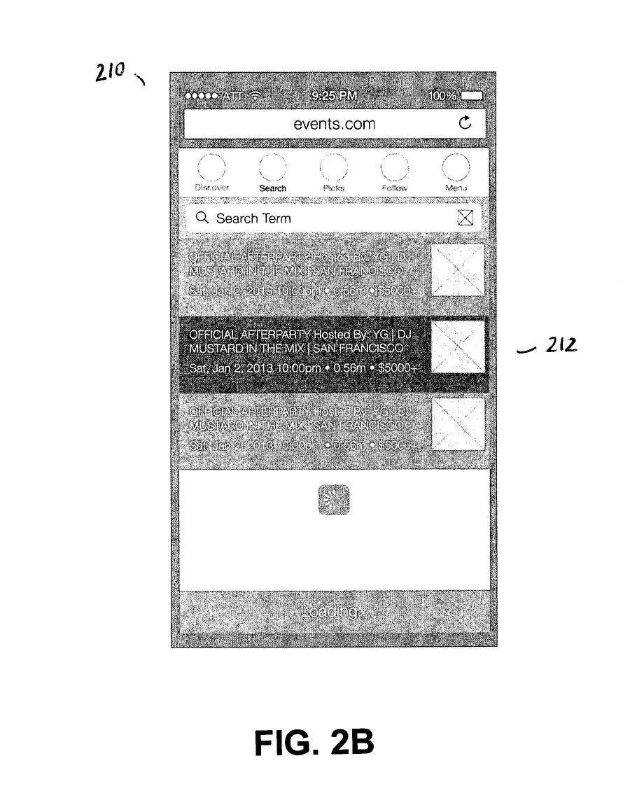

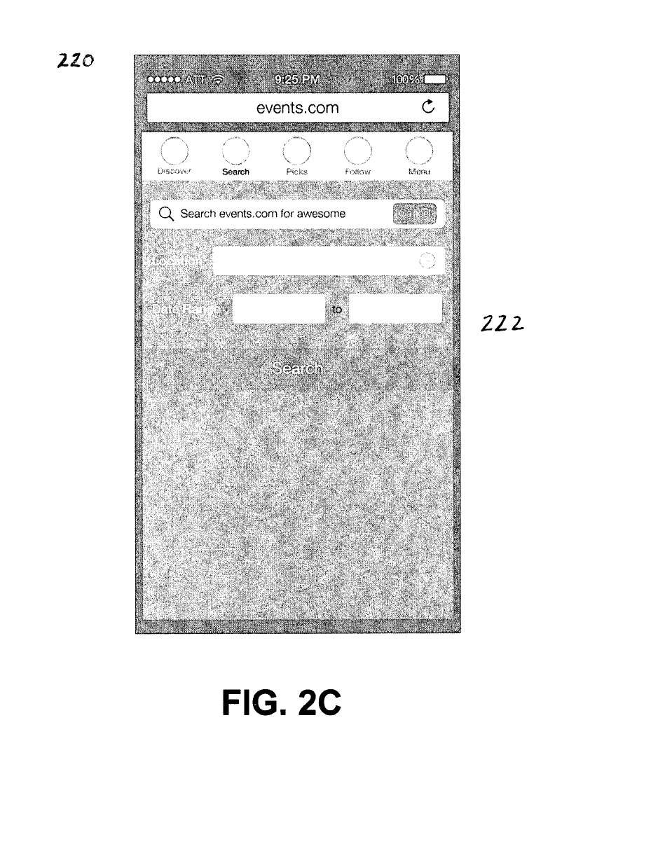

Upon accessing the event management platform 112, a user is displayed a zoom-able, pan-able map and vertical calendar (list) interface, which will request the user's location, or default to the user's current location should the user give the platform permission to access their location through the browser. FIG. 2A illustrates an example web page showing a map view for search visualization, under an embodiment. As shown in display window 200, the main user interface includes a selection input menu 202 that allows the user to specify which action he or she would like to take, such as discover events, search for events, view picked events, follow events, and access other menu items. As shown in FIG. 2A, the ‘search’ option is selected, which generates a search input area 204 that allows the user to input a text search string.

A currently viewed event or advertising message may be displayed in display area 208. Display window 200 includes a map display area 206 that allows the user to specify a geographical location for the platform to center on, with granularity ranging from a specific latitude/longitude geographic coordinate to the entire globe. This allows the platform to display a graphical representation of the personalized result of the search query, and provides a viewport that is responsive to map moves and zoom actions. As the view changes, the events can be updated accordingly. FIG. 2B illustrates an example web page showing a vertical calendar (list) interface view for search visualization, under an embodiment. This provides a secondary viewport that can be displayed by toggling from the map view 200. As shown in FIG. 2B, display window 210 includes a list display area 212 that shows one or more events that correspond to events shown on the map 206. Results are consistent between the map and list views and are displayed in order of preference according to personalization criteria based on interest weights for the users and other relevant criteria.

In the active search state the time and location selectors allow users to specify additional variables with which to filter relevant events, before or after a keyword query is searched, and without having to navigate away from the map/calendar viewport and search interface. FIG. 2C illustrates an example of a semantic/keyword driven search interface, under an embodiment. As shown in FIG. 2C, display window 220 includes an input area 222 that allows users to search a word (or words) of varying length, and further qualify or narrow the search based on factors such as location, date, price, and so on. When the query is submitted the platform runs it through a relevancy algorithm in order to return the best possible results from a large event database to deliver results in orders weighted uniquely to the querying users' personalizations. The personalization information may be obtained from profile data, if the user has a pre-established account. Alternatively it may be inferred based on certain user characteristics, such as location, age or gender, obtained through the browser or from third party data and user profiling services. The platform's relevancy algorithm is self-learning, in the sense that it adapts itself based on, amongst other variables, user interaction with the site. The events database 120 or 122 contains a collection of events of all types from across the web, with event data from third party sources (e.g., ticket sellers, venue managers, event blogs, other event repositories, etc.) as well as from direct user submission of events through the platform.

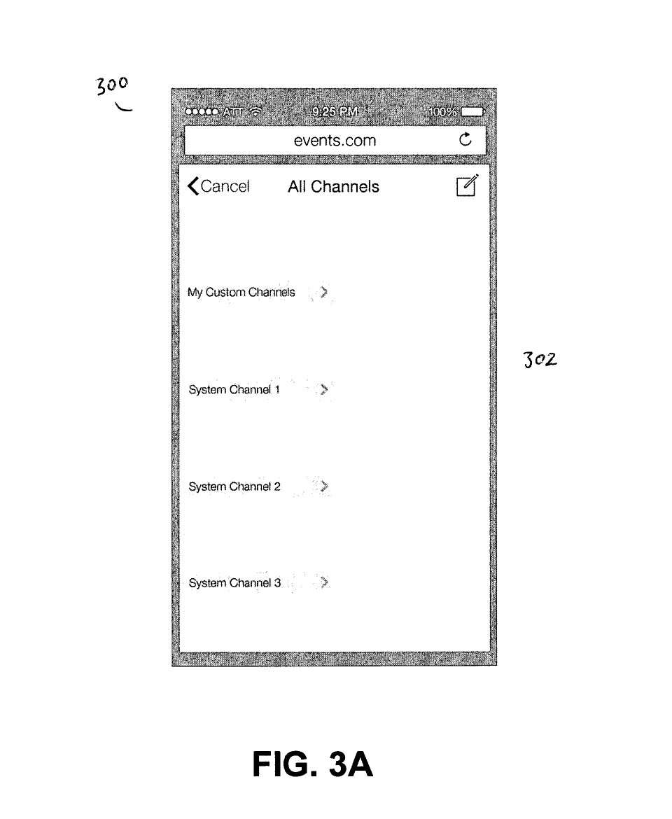

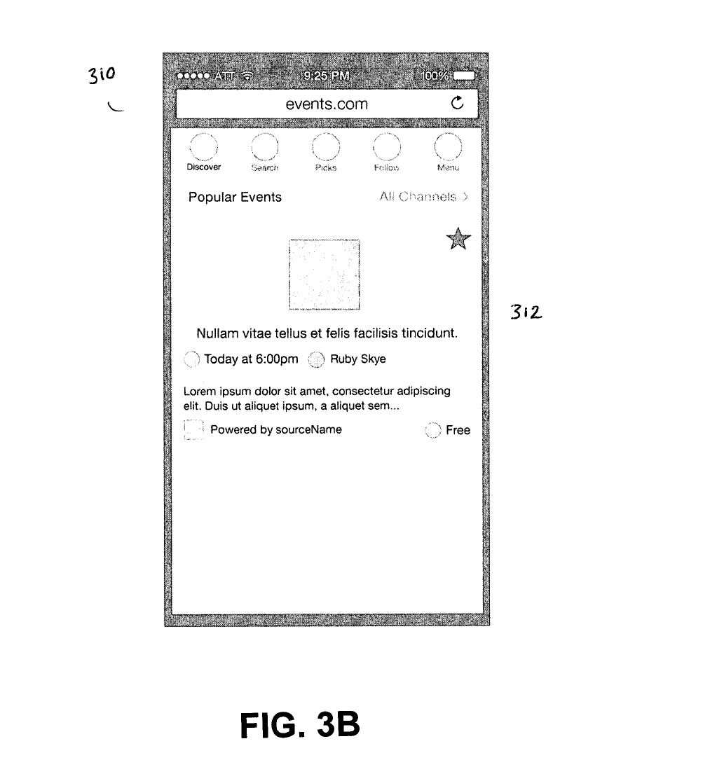

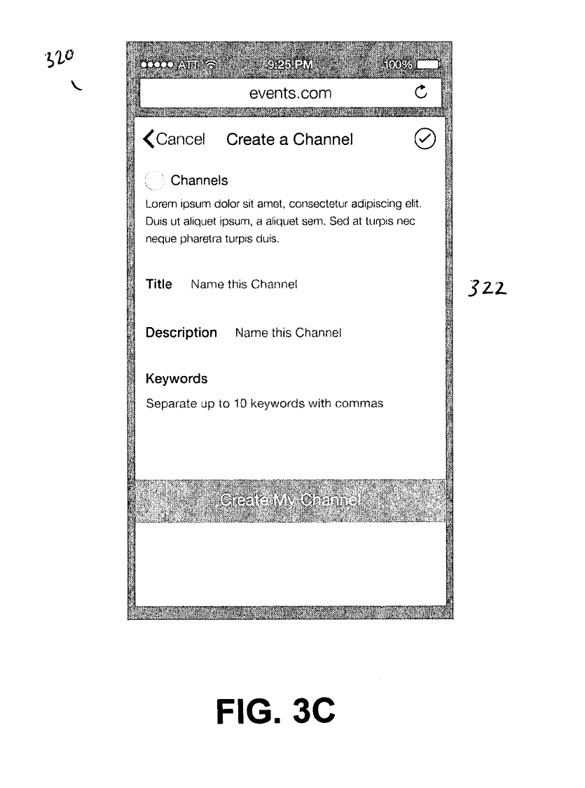

In an embodiment, in addition to the map and vertical calendar (list) search screens 200 and 210, a user may be presented with a selection of channels, and options to create further channels. A user will presumably either come to the platform with the goal of discovering an event sometime in the past, present, or future, or arrive by specific referral link direct to an event or entity through either a third party web property or search engine, link share, internal notification from the platform or invitation. A channel-driven search is a passive search based on saved previous searches that are indexed by keywords, locations, times, and popularity driven logic. The channels are also influenced by personalization based on user account information. FIG. 3A is an example web page illustrating a channel-driven search page, under an embodiment. As shown in display window 300 of FIG. 3A, a number of different channels 302 may be defined to display previous searches based on certain criteria. These are listed as custom channels and any number of system channels. For example, channels may include popular events (e.g., based on searches, attendance, etc.), live music, sports, happy hours, technology, art & theatre, charity, networking, etc. Channels may be defined by the platform based on certain recognizable keywords of an event, such as music, sports, movies, etc. or they may be defined by index words used to identify a specific event type. Alternatively, channels may be defined by the user. FIG. 3C is an example web page illustrating a custom channel display screen, under an embodiment. Display screen 320 includes a user input area 322 that allows a user to create a channel by specifying a title, description, keywords, and other relevant parameters. A custom created channel will then be displayed in display screen 300 of the channel-driven search window. A selected channel is displayed through a channel visualization window, such as shown in FIG. 3B, which illustrates an example web page for channel visualization, under an embodiment. Display window 310 illustrates a sub-view for the ‘popular events’ channel and lists the particulars for one or more events in this channel.

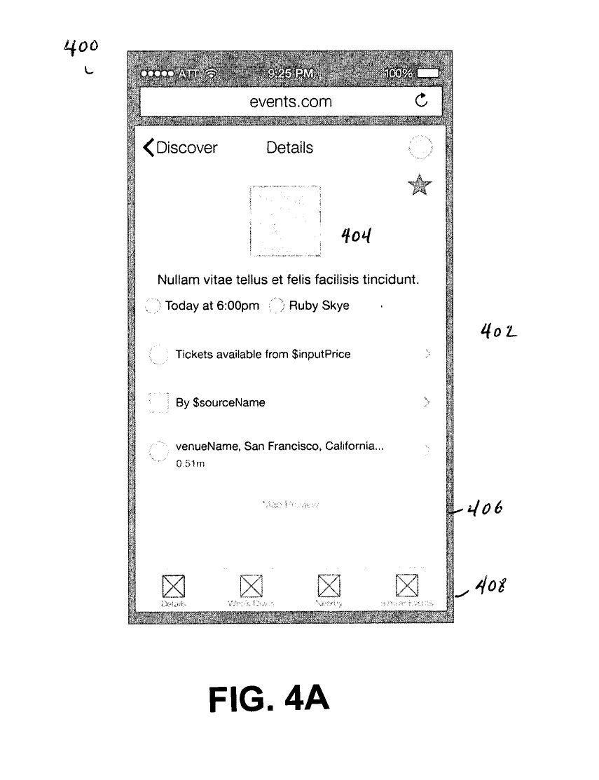

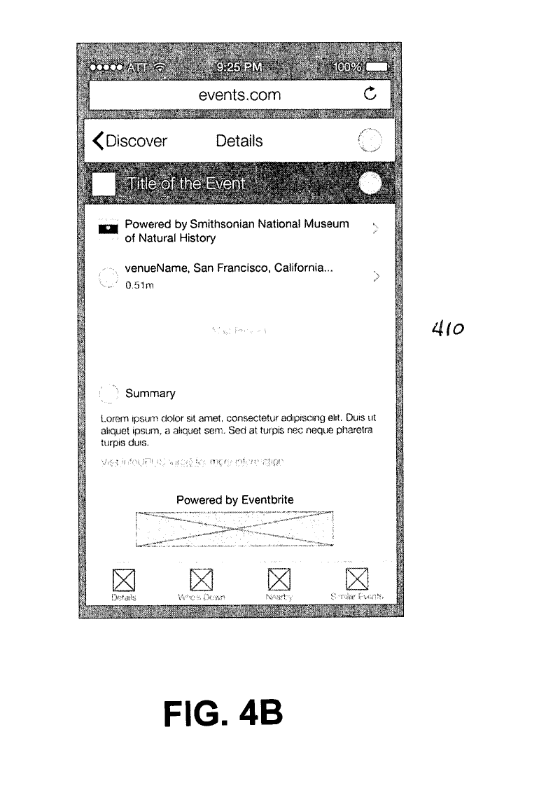

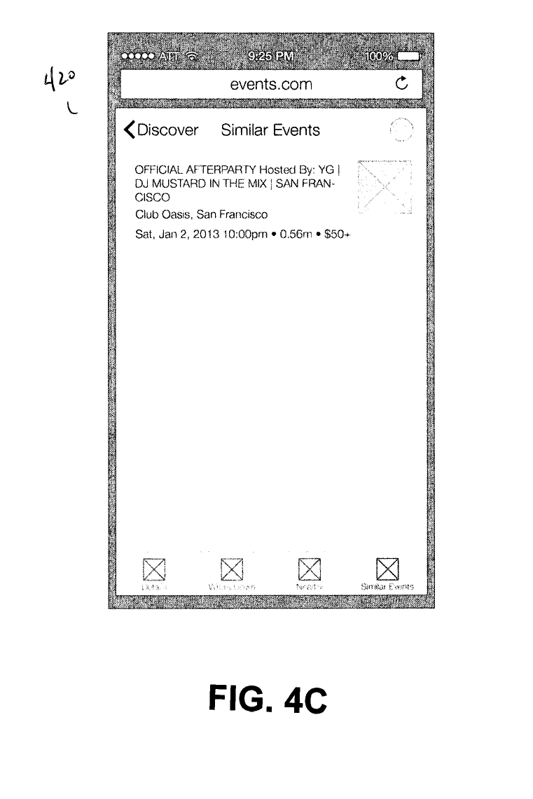

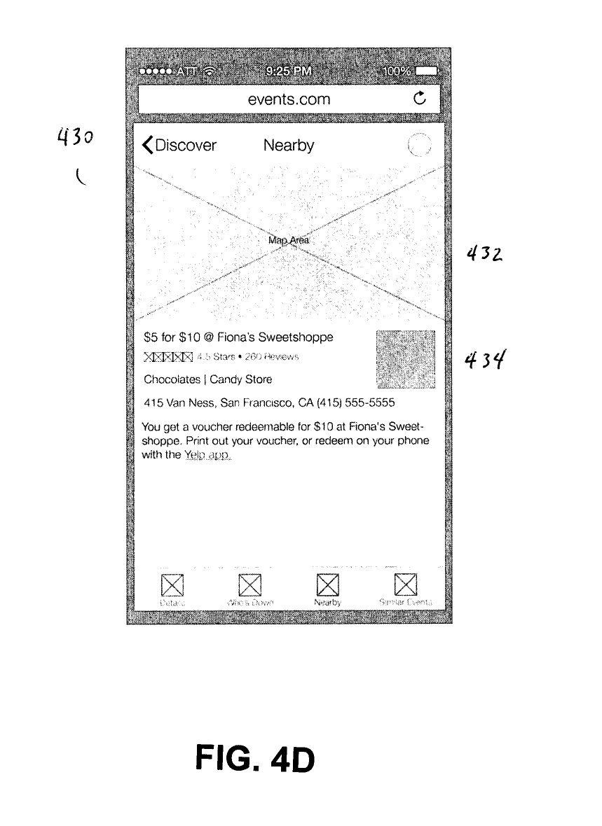

In an embodiment, a search is returned to the user as a visual representation in the platform GUI. This may be displayed in the form of graphic “pins” on the map viewport 206, or a series of such representations, provided a match to the query was found. A user can then click into any individual event from its respective pin and have relevant event information displayed in an event panel, which overlays on a portion of the map, (without leaving the interface). FIG. 4A is an example web page illustrating an event display viewport, under an embodiment. Upon selecting an event ‘pin’ from the map view, or an event title from the list view, display window 400 shows the details of the selected event in display area 402. The example event may have a picture, video clip, or descriptive information 404 accompanied by relevant information such as time, location, duration, ticket cost, venue name, and so on. A map view 406 of the exact location may also be provided. In certain cases, event information may not fit in a single display area, in which case the information may be scrolled such as shown in FIG. 4B, in which case display area 410 illustrates additional information accessed through scroll bars or other page change interface elements in the event display viewport 400.

As shown in FIG. 4B, within an event panel a user is presented with several tabs, the collection of which contain information a user may wish to know about a given event; description, time and location, directions, media gallery, ticketing, and more. Should a user wish to visualize the results for several search queries simultaneously, the platform can provide second queries and have the related events represented distinctly within the viewport (such as by using uniquely colored pins), while the visual representations of previous queries remain displayed in the same viewport; the same is true for each successive consecutive query. Any query for which a user no longer wants to see results for can be removed from the search query, at which point its associated visual representation(s) would disappear from the viewport.

The embodiments shown illustrate the viewing of an event through the map viewport, but it should be noted that all of the above actions can also be performed through a calendar/list interface rather than the default map UI. In an embodiment, a user can accomplish this by a switch in the interface viewport. If a user selects to switch views then the map section will be replaced with a vertical calendar (list) viewport as shown in FIG. 2B, where events are displayed by date rather than relative location. The switch between the two interfaces is seamless, with consistent data being displayed across both viewports in an easy to understand fashion.

As shown in FIG. 4A, the event viewport 400 also includes in interface area 408 that allows the user to find related or relevant events based on similarity or location characteristics through interface elements labeled “similar events” and “nearby”. These buttons constitute a passive search function that provide event finding through characteristics associated with searched events. FIG. 4C is an example web page illustrating a similar event response, under an embodiment. Display window 420 shows a description of an event that is similar to the event that was searched for and displayed in a first event display window 400. Similarity between events is defined according to rules specified by the platform. This represents a passive discovery experience that is embedded into an event to increase user engagement through a continuation of a ‘similar’ event discovery loop. Each event results in a dynamic search based around the categorization and features relating to an event. Each event has a unique ‘feature fingerprint’ and runs specific searches to unearth similar events. FIG. 4D is an example web page illustrating a nearby event response, under an embodiment. The nearby event search result may be triggered by events that are within a defined radius or geographical location and/or time of the searched event. Display area 430 of FIG. 4D includes a map 432 and description of any relevant nearby events. FIG. 4D also illustrates a deal visualization case in which deals may be provided by vendors to be accessed through the event viewport. In this case, a nearby event may comprise a deal or voucher 434 that is made available for redemption by a vendor near or related to an event.

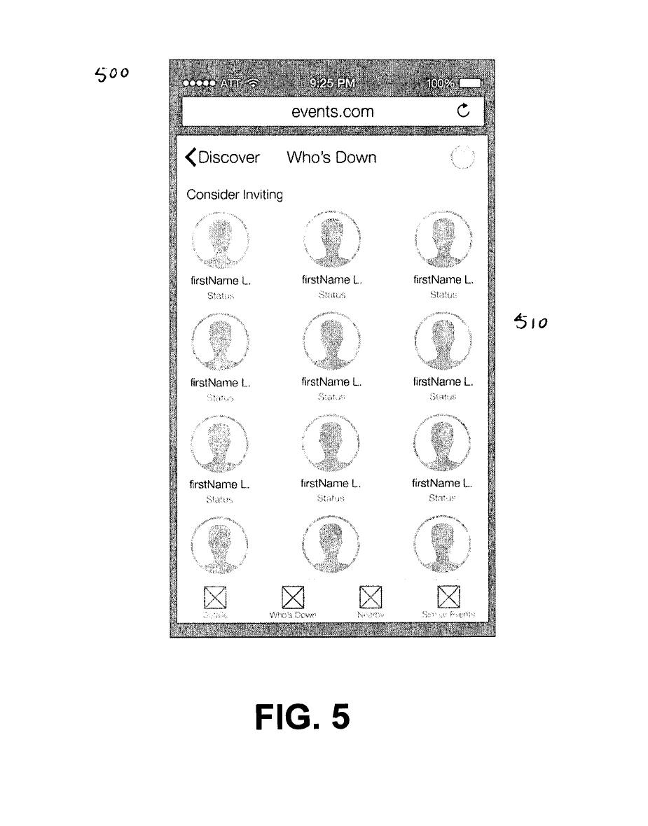

In an embodiment, the platform also includes a social network aspect that allows a user to involve other people (friends, families, co-workers, associates, etc.) to participate in an event. As shown in FIG. 4A, a “who's down” command button provides access to a social network type interface that allows the user to involve other people. Individuals shown on the “who's down” screen are selected from a user's immediate social graph and ordered by, among other indicators, predicted likelihood of attendance based on any known interests of the individuals in question, if available, and the overlap of those interests with the event currently being viewed by the user. FIG. 5 illustrates an example web page for a social share screen, under an embodiment. As shown in display area 500 of FIG. 5, a social network display area 510 shows the names and/or images of people known to the user. Such names may be populated through other social networks used by the user, such as Facebook, Twitter, Linked-In, etc., or it may be populated by the user directly through the platform UI. Selecting a particular person in the selection area 510 indicates that the person is invited or otherwise alerted to the event, and a status indicator may be changed accordingly. The interface may include mechanisms to notify the person through appropriate means, such as e-mail, tweet, Facebook alert, and so on. This feature represents an implicit share action to drive conversation around an event by suggesting other individuals who would be interested from the user's own friendship graph. The order of people displayed in display area 510 may be programmatically determined according to external and internal interest graph signals.

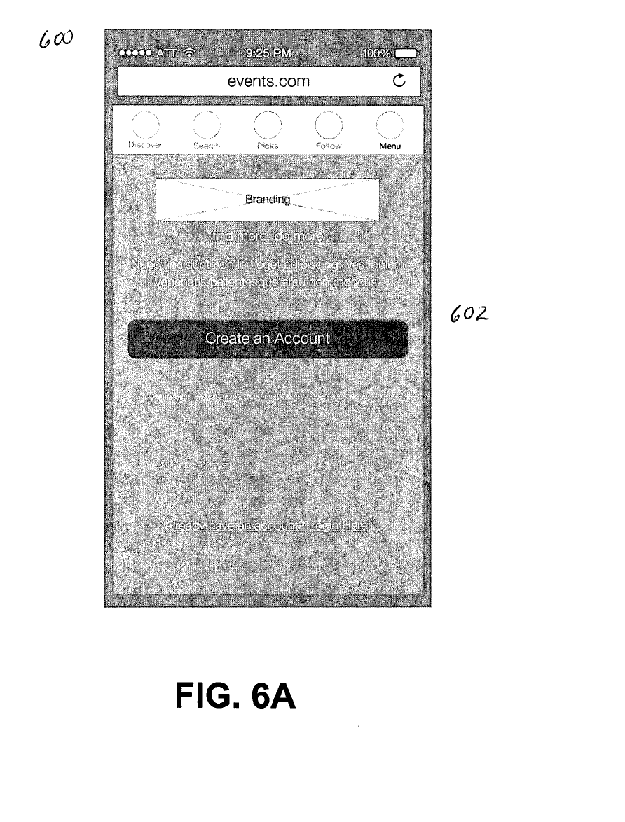

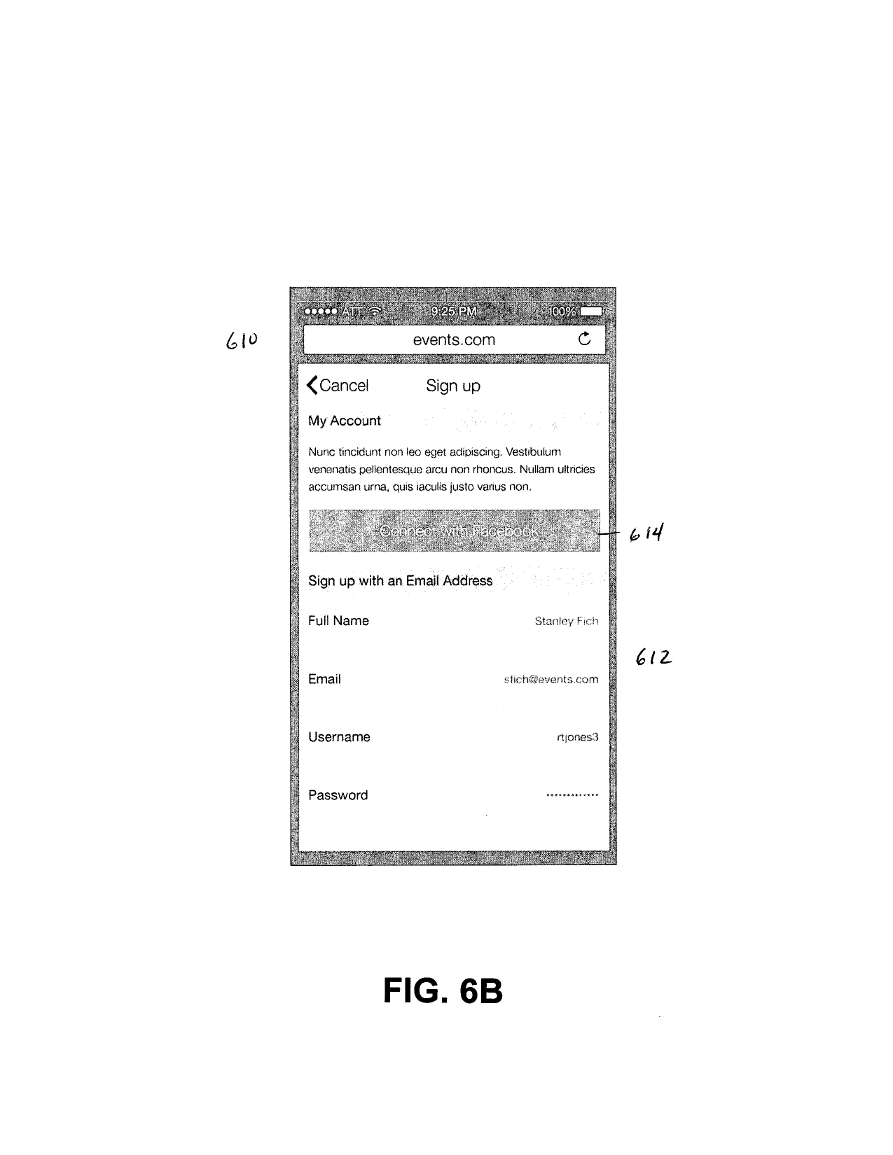

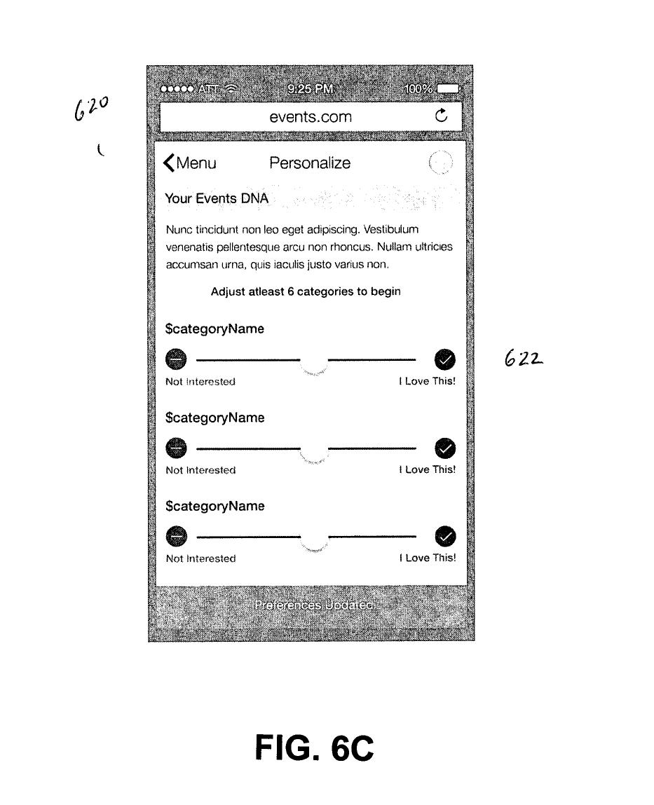

The menu function of the platform allows users to personalize certain aspects of the platform. FIG. 6A is an example web page of a personalization feature, under an embodiment. Display area 600 illustrates a possible first page of the ‘menu’ section of the platform. This shows a user sign-up display area 602 with a “create and account” command button, as well as a branding display area section. The branding display area may display commercial or advertising messages, logos, links or other relevant content. This may be implemented as a splash page inside of the menu to act as a conversion trigger to educate unsigned-in users as to the value proposition of the application. Signup preferences may also be personalized. This provides the ability to link social accounts to simplify the signup process and provide external indicators to the application for use in personalization and relevancy. It also facilitates the linking of externally identified event specific signals across social profiles as implicit indicators of interests, such as by link sharing of events, geo-specific/temporal content submission and checkins and/or engagement with venues, consumption of media and/or contribution of comments around a venue or event. FIG. 6B is an example web page of the personalization of signup preferences, under an embodiment. As shown in FIG. 6B, the signup preference page 610 includes an account information section 612 that lists certain identifiers for the user, such as name, contact information (e.g., e-mail, phone, etc.), user name, password, and other identifiers. Certain security or password backup mechanisms may also be used, such as code words, and so on. A link area 614 may also be provided to link directly to other applications or social networking sites (e.g., Facebook) to facilitate signup through existing user accounts.

Another aspect of personalization is one in which specific events or categories of events may be rated or otherwise indexed to provide an indication of user preference or rating of events. The platform allows users to rate their preference from a variety of categories, and these ratings are used as signals amongst other indicators to generate personalized suggestions with respect to other displayed or potentially displayed events. These drive recommendations throughout the platform and can adjust automatically based on users' engagement of the events. Users are notified through a variety of passive triggers that include platform push, such as through e-mail newsletters, mobile push and notifications, among others. FIG. 6C is an example web page of the personalization of events, under an embodiment. As shown in event personalization display 620, rating scales are associated with a number of different categories displayed in display area 622. The rating scale can be a linear scale from ‘not interested’ to ‘I love this’ or any other appropriate scaling methods, such as a letter grade or numeric ranking, etc.; and the categories may be events or groups of events.

### Event Management Platform

In addition to the discovery of activities, the platform 112 allows users amongst other capabilities to create, share, save, disseminate, and otherwise manage events/activities. Users have the ability to add new events to the platform's event database, which can be either privately shared or made publicly searchable, depending on a user's goals and account privileges. All users have the ability to create event streams, collections of events, allowing for the creation of groups of events as chosen by the user. As with individual events, streams of information (calendars of events) can be either privately shared or publicly searchable, again depending on the user's goals and account privileges. Certain users have the ability to create and manage multiple personas (“brands”) under a single account, any of which can be assigned “ownership” of an event or event stream created by the account. This effectively allows further segmentation of events and streams to simplify the management of brands. Users who create an event through the platform have the ability to modify the contents of the event's event panel. This includes, but is not limited to, adding or editing: the event description, image gallery, time and location, links to external sites and social networks, ticketing information, and privacy settings.

The platform includes extensive calendar functionality to facilitate easy sharing of events and schedules. Users can choose to add events or streams to their own calendars, whether it is to the platform's native calendar or to a third party calendar (e.g., Google Calendar or iCal). Users can share their calendar with other users, allowing users to easily determine when their peers are free or busy, for the purpose of group planning. Users who sync their personal/professional calendars with the platform will also have the option to have the platform automatically exclude events occurring during “busy times” from the result list returned by any/all queries. As long as synced calendars are kept up to date, this allows the platform to personalize each user's experience and ensure they are shown only relevant information. The platform can also be used to disseminate events or send communications, including to third parties such as social networks, event aggregation websites, individuals' phone numbers/email addresses, and other destinations.

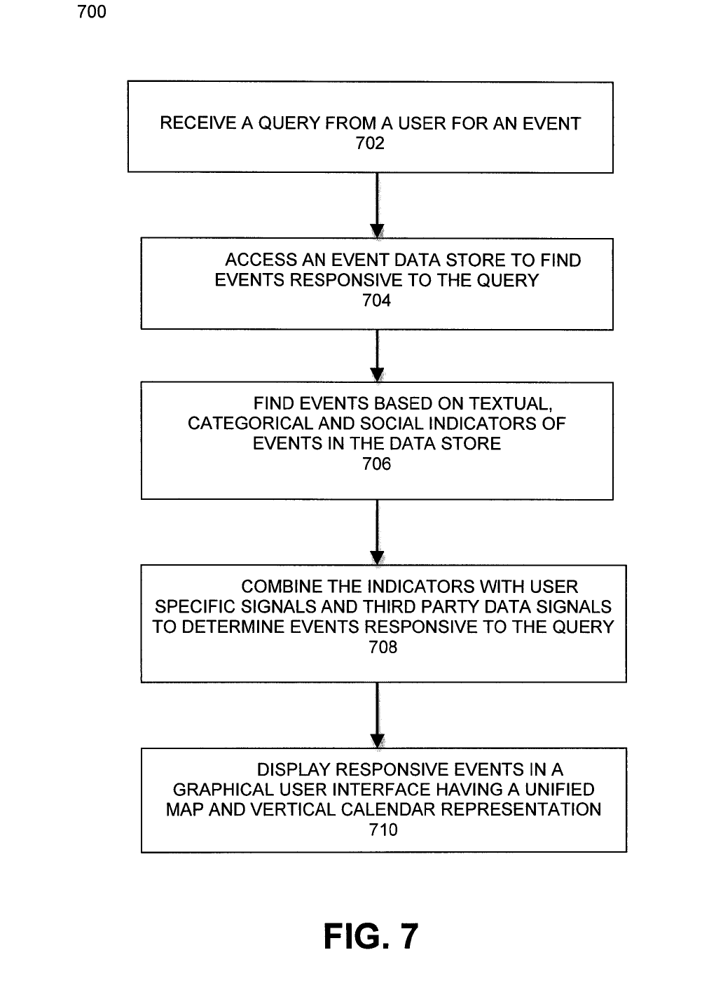

FIG. 7 is a flowchart that illustrates an overall method of managing and processing searches for events through an event management platform. As shown in process 700, the method starts by receiving a query input into a search engine component configured to allow a user to enter one or more parameters initiate a search to locate an event for an intended audience of one or more other users, block 702. The process then accesses an event data store to return event results, block 704. This may entail performing a relevancy determination to return results for the search from the event data store based on textual, categorical, and social indicators of an event, block 706. The process combines the textual, categorical, and social indicators with user specific signals and third party data signals and user profiling to generate the result, block 708. The process then notifies and delivers the results to the user by displaying to the user through a user interface one or more results in a single unified map and vertical calendar graphical representation, block 710.

The various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for managing events, comprising:
a search engine component configured to allow a user to enter one or more parameters initiate a query to locate an event for an intended audience of one or more other users;
a database interface configured to access and return results from an event data store;
a relevancy engine returning results for the search from the event data store based on textual, categorical, and social indicators of an event;
a component to notify and deliver the results to the user; and
a user interface displaying to the user one or more results.

2. The system of claim 1 wherein the query comprises a keyword search string.

3. The system of claim 2 wherein the relevancy engine is configured to combine the query with categorical and other indicators, including social indicators, with user specific signals and third party data signals to generate the result specific to the user.

4. The system of claim 1 wherein the search comprises a query that may include keyword search string to derive dynamic search channels that can be generated by at least one of: an automatic process executed by the system, customization input by the user, user engagement with any content originating from a platform executing the search engine.

5. A system of claim 4 wherein the query powering the dynamic channels are defined by the user.

6. The system of claim 1 further comprising a location component determining a location of the user through one of a default means comprising at least one of: application location query or IP address lookup, or direct user input, and wherein the location of the user is processed to generate location specific results.

7. The system of claim 1 further comprising a scheduling component determining time information related to events stored in the event data store and availability of the user, and wherein the time information is processed to generate results, which can be later displayed in multiple representations including map, list, and calendar representations.

8. The system of claim 1 further comprising a social network platform configured to allow the user and one or more users to share information provided by the application.

9. A method of managing events and user schedules, comprising:
receiving and processing a query from a user to locate an event to be considered for attendance by zero or more other users;
accessing information regarding location and schedules of events from an event data store to return search results to the query;
accessing information regarding location and schedules of the user and the zero or more other users; and
providing a user interface for display of the search results to the user.

10. The method of claim 8 further comprising a social network or other external platform configured to allow the user and zero or more other users to specify personal information and to share information provided by the event data store.

11. A method of returning results to a user with the use of relevancy indicators based on one or more of the following to determine the results to be returned:
information derived from interactions of the user with other users who have volunteered their data from one or more external networks;
third party profiling services that have granted access to the information; and
linking of externally identified event specific signals seen across third party platforms to specific user profiles.
